(19) United States
(12) Patent Application Publication
(10) Pub. No.: US 2003/0033170 A1
(43) Pub. Date: Feb. 13, 2003

(54) Economic impact analysis tool for equipment under warranty

(76) Inventors: Vivek Bhatt, Wauwatosa, WI (US); Michael G. Brokloff, Waukesha, WI (US); Leonard L. Caccese, Pewaukee, WI (US)

Correspondence Address: FLETCHER, YODER & VAN SOMEREN, P. O. BOX 692289, HOUSTON, TX, 77269-2289, US

(21) Appl. No.: 09/682,246

(22) Filed: Aug. 9, 2001

(51) Int. Cl. G06F 17/60

(52) U.S. Cl. 705/4

(57) ABSTRACT

The present technique provides a method and system for analyzing the economic effect of a product warranty associated with a product. The technique utilizes a statistical model of the failure rate of the product. The technique also utilizes economic data associated with the product and the warranty. The technique performs convolutions of the economic data and the statistical model of the failure rate of the product to identify an effective cost of the product and an effective selling price for a replacement product for a failed product. The effective cost, effective selling price data, and variation in profit margin for the product are determined for a range of warranty durations and warranty types. This data enables a user to quantitatively analyze the effect of variations in product warranties.

### BACKGROUND OF INVENTION

The present invention relates generally to an economic analysis tool. Particularly, the present invention relates to an economic analysis tool to evaluate various pricing and warranty scenarios for a product based on a statistical model of the operating life of the product.

Many products are sold with a product warranty. The warranty may be a full warranty, in which the warrantor agrees to pay all of the costs associated with the repair of a failed product, including the cost of a replacement product, if needed, and the cost of labor to repair the product. Alternatively, the warranty may be a limited warranty, in which the warrantor agrees to pay for some, but not all, of the costs associated with the repair or replacement of a failed product. For example, a warrantor may provide a scaled warranty that gives a customer a discount from the list price for the purchase of a replacement product that decreases over the lifetime of the warranty. Alternatively, a warrantor may provide a warranty that combines a full warranty for a first period of time, followed by a limited warranty for a second period of time.

A warranty provides an assurance to the customer that the customer will not bear the entire cost of repairing or replacing the product if the product fails during the life of the warranty. Typically, a customer has only a few warranty options, if any, from which to choose. However, a customer may be given the option to purchase extended warranty protection beyond the coverage normally provided by the warrantor. Additionally, in some cases a customer may even be able to negotiate the terms of the warranty with the warrantor.

Estimating the potential cost of providing a warranty involves several factors. The terms and conditions of the product warranty will be major factors in estimating the potential cost of providing a warranty. A longer warranty would be expected to cost more than a shorter warranty because the likelihood of a claim being made against the warranty is greater. Additionally, a full warranty would be expected to cost more than a limited warranty because the potential replacement and/or repair costs that would be contributed by the warrantor are greater. Finally, the probability that a product will fail during a warranty period will affect the potential cost of providing a warranty. The potential cost of providing a warranty is greater the more likely it is that the product will fail during the warranty. However, attempts to incorporate economics into establishing the terms and conditions of warranties has, typically, been a matter of guesswork and thumb rules. This can be especially problematic when negotiating with a customer over the terms and conditions of the warranty. No tool has been available to enable a warrantor to perform a quantitative economic analysis of the costs and benefits of providing a warranty to a customer for a variety of warranty scenarios.

There is a need, therefore, for an improved approach to establishing the provisions of a warranty by quantitatively analyzing the economic effects that result from providing the product with a warranty. In particular, there is a need for a technique that incorporates a statistical model of the expected failure rate of a product to enable a quantitative economic analysis of the cost of providing the product with a warranty to be performed. Additionally, there is a need for a technique that incorporates a statistical model of the expected failure rate of a product in a quantitative economic analysis of the selling price that may be obtained for any replacement products that may be sold to a customer. Furthermore, there is a need for a technique that enables a quantitative analysis to be performed of the variation in the profit margin that would result from providing the product with a warranty.

### SUMMARY OF INVENTION

The invention provides a novel technique for analyzing the economic impact of a product warranty associated with a product. The technique utilizes a statistical model of the failure rate of the product. The technique also utilizes economic data associated with the product and the warranty. The technique performs convolutions of the economic data and the statistical model of the failure rate of the product to identify an effective cost of the product and an effective selling price for a replacement product for a failed product. The effective cost, effective selling price data, and variation in profit margin for the product are determined for a range of warranty durations and warranty types. This data enables a user to quantitatively analyze the effect of variations in product warranties.

### BRIEF DESCRIPTION OF DRAWINGS

FIG. 1 is a block diagram of a process to establish a product warranty using an economic model of the costs and benefits of providing a warranty to a customer,

FIG. 2 is a chart of a statistical model of the unreliability of a product over time;

FIG. 3 is a chart of the actual selling price that a warrantor may charge for a replacement product over time for a product having a warranty;

FIG. 4 is a chart of the actual cost to the warrantor over time of a product having a warranty;

FIG. 5 is a diagrammatical representation of an economic model to quantify an effective selling price for a replacement product;

FIG. 6 is a diagrammatical representation of an economic model to quantify an effective cost of a product having a warranty;

FIG. 7 is a block diagram of a computer system operable to provide a user with a warranty economic tool;

FIG. 8 is a three-dimensional chart illustrating the effective selling price variation as a function of the warranty;

FIG. 9 is a three-dimensional chart illustrating the effective cost variation as a function of the warranty; and

FIG. 10 is a three-dimensional chart illustrating an effective profit margin variation as a function of the warranty.

### DETAILED DESCRIPTION

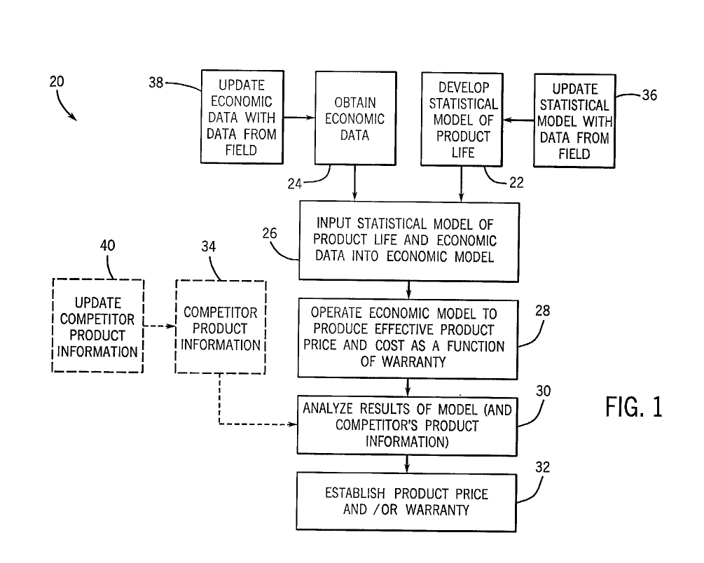

Turning now to the drawings, and referring first to FIG. 1, a process 20 is illustrated for establishing a product warranty using a quantitative cost-and-benefit analysis. The process 20 uses an economic analysis tool that incorporates a statistical model of a products failure rate, as represented by block 22, and economic data, as represented by block 24. The economic data may vary from product to product. Examples of economic data that may be included are the list price of the product, the selling price of replacement products, and the cost of installing a replacement product. The statistical model of product life and the economic data are entered into the economic analysis tool, as represented by block 26. The economic analysis tool then produces an effective selling price of a replacement product for a product having a warranty and an effective cost of the product, as represented by block 28. Additionally, the analysis tool provides a user with the effective replacement product selling price and effective product cost over a range of warranty periods so that the effect of variations in the warranty period on the effective cost and selling price can be seen.

The economic analysis tool also uses the effective replacement product selling price data and the effective product cost data to provide a user with the variation in the profit margin for the product resulting from the product having a warranty. The analysis tool is operable to provide the economic information not only for warranties having different durations but also for different types of warranties, such as full and scaled warranties. A user then analyzes the results of the economic analysis tool, as referenced by block 30, and establishes the terms and conditions of the product warranty based on the quantitative results of the economic model, as represented by block 32. A product warranty may be established unilaterally by the warrantor or through negotiations with a customer. The economic analysis tool enables the warrantor to analyze the economic impact, e.g. profit margin, of any warranty proposed by a customer during the negotiations.

Additionally, a competitor”s warranty information can be included in the analysis of the results of the economic analysis tool, as represented by block 34. For example, the results of the economic analysis tool may indicate that a warranty that is longer than that provided by a competitor can be provided profitably. The economic analysis tool also is dynamic, allowing for the statistical model of product life to be updated with new data obtained from the field, as represented by block 36. Additionally, changes in the economic data can be updated in the economic model, as represented by block 38. Furthermore, changes in the competition”s warranty also can be updated periodically, as represented by block 40.

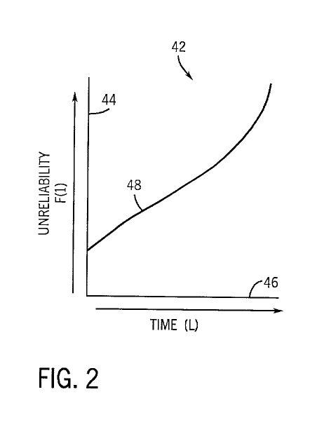

Referring generally to FIG. 2, a failure distribution is used to develop a statistical model 42 of a product”s failure rate. In this embodiment, a Weibull distribution is used to develop the statistical model 42 of a product”s failure rate. The Weibull distribution is often used to describe the lifetimes of parts, such as light bulbs, capacitors, ball bearings, etc. When a number of parts, or products, are tested, they don”t usually fail at the same time. Typically, the time to failure varies. If parts fail according to a Weibull distribution, the probability that any single part will fail at a particular time, “t” is given by the equation: F(t)=1−exp[−(t/a)^{b}], where “a” is called the scale parameter, “b” is called the shape parameter, and “F” is called the cumulative distribution formula. If the scale parameter and the shape parameter are known, then the probability of failure, F, can be calculated for any time, “t.” As is known by those skilled in the art, the scale and the shape parameters can be estimated from the data. In the illustrated Weibull distribution, the horizontal axis 44 represents time and the vertical axis 46 represents the unreliability, or cumulative probability of failure, of the product. A log-log scale is used for the distribution. A curve 48 of the failure data plotted on the distribution is used to establish the function of the unreliability of the product.

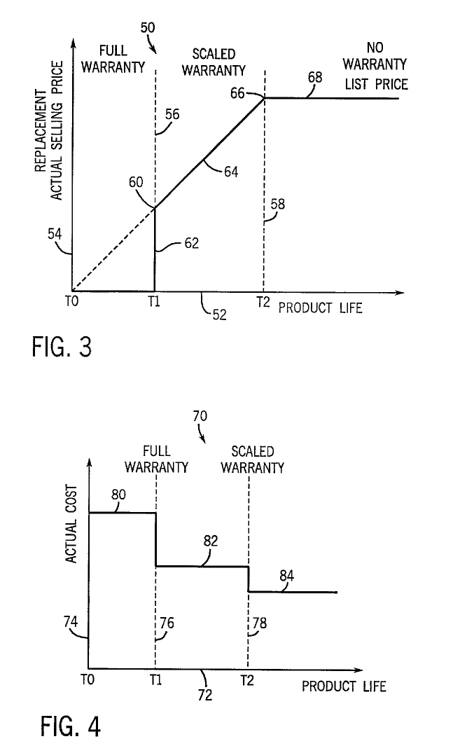

Referring generally to FIG. 3, a chart 50 is provided to illustrate the actual selling price that a warrantor may obtain over time for a replacement product having a two-tiered warranty. In the illustrated chart, the horizontal axis 52 represents time and the vertical axis 54 represents the actual selling price that a warrantor may obtain from a customer for the replacement product. The warranty is two-tiered in that the customer is provided with a full warranty followed by a scaled warranty. The full warranty extends from the time the product is purchased, as represented by time “T0”, to time “T1”, as represented by line 56, followed by a scaled warranty from time T1 to time “T2”, as represented by line 58.

In the illustrated embodiment, the actual selling price of a replacement product during the full warranty period is $0 because the warrantor provides a replacement to the customer at no cost. The scaled warranty provides the customer with a decreasing discount from the list price of the replacement product. In the illustrated embodiment, once the full warranty has expired, the actual cost to the customer of a replacement product rises to an initial selling price 60, as represented by line 62. From that point on, the actual selling place rises linearly, as represented by line 64, from the initial selling price 60 to the full list price 66 at the expiration of the scaled warranty. In this embodiment, once the limited warranty has expired, there are no more discounts available to the customer for purchasing replacement products and the customer must pay full list price for any replacement products purchased, as represented by line 68. The actual selling price of a replacement product can be expressed mathematically as a function of time. In the illustrated embodiment, the function is dependent on the durations of the full and the scaled warranty, the initial selling price after the expiration of the full warranty, and the list price of the product at the end of the scaled warranty.

Referring generally to FIG. 4, a chart 70 of the actual costs that a warrantor may experience over time for a product with the two-tiered warranty of FIG. 3 is illustrated. In the illustrated embodiment, the warranty provides that the warrantor will pay for a replacement product and for the installation of the replacement product during the full warranty period. During the scaled warranty period, the warrantor pays for the cost of installing the replacement product, but not the cost of the replacement product. In the illustrated chart, the horizontal axis 72 represents time and the vertical axis 74 represents the actual cost that a warrantor may experience due to the failure of a product. The full warranty extends from the time the product is purchased, as represented by time “T0”, to time “T1”, as represented by line 76, followed by a scaled warranty from time T1 to time “T2”, as represented by line 78.

The actual cost of a product that fails during the full warranty period, as represented by line 80, is the cost of the original product and the installation of the original product plus the cost of the replacement product and the installation of the replacement product. The actual cost of a failed product during the scaled warranty period, as represented by line 82, is the cost of the original product plus the cost of the original and replacement installations. The cost of a failed product to the warrantor after the scaled warranty has expired, as represented by line 84, is simply the cost of the original product and the cost of the initial installation of the original product. The actual cost of a product can be expressed mathematically as a function of time. In the illustrated embodiment, the function is dependent on the duration of the full and the scaled warranties, the cost of the product, and the cost of installing the product.

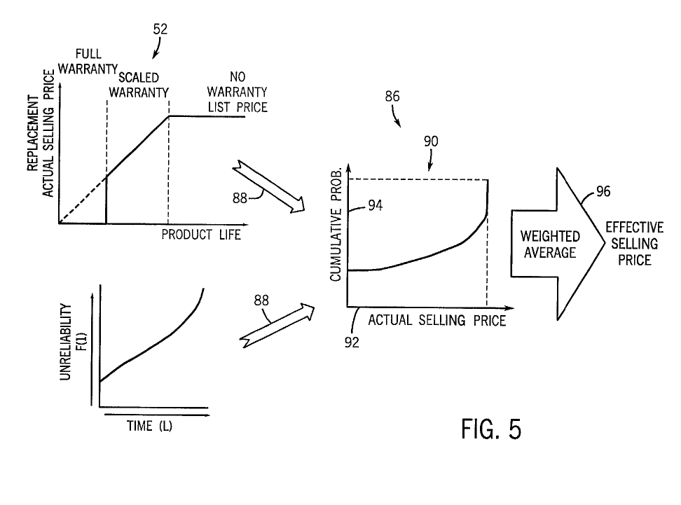

Referring generally to FIG. 5, a process, generally designated by the reference numeral 86, for obtaining an effective selling price for a replacement product is illustrated. In the illustrated process, a convolution of the data in the chart 52 of FIG. 3 and the statistical model 42 of FIG. 2 is performed, as represented by arrows 88. The result of the convolution is a cumulative probability distribution 90. The horizontal axis 92 of the distribution 90 is the actual selling price and the vertical axis 94 is the cumulative probability of obtaining an actual selling price. The process 86 takes the average of the actual selling prices weighted by their respective cumulative probabilities, as represented by arrow 96. The weighted average is the effective selling price for a replacement product having a specific product warranty.

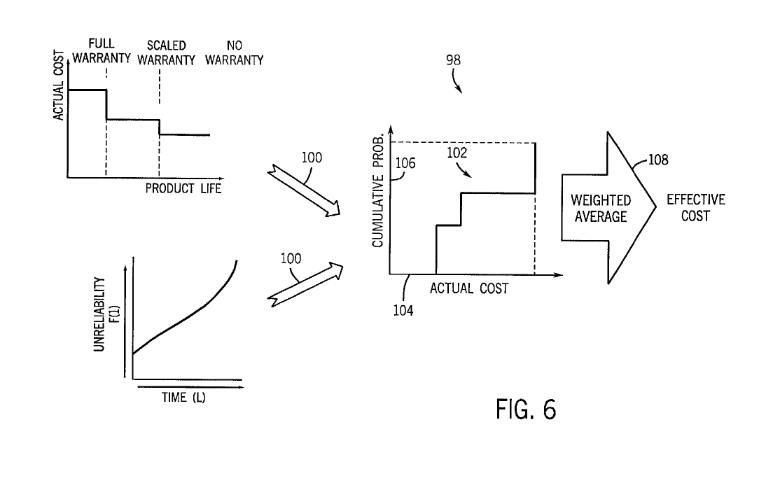

Referring generally to FIG. 6, a diagram of a process, generally designated by the reference numeral 98, of obtaining an effective cost of a product having a product warranty is illustrated. In the process, a convolution, as represented by arrows 100, of the data in the chart 70 of FIG. 4 and the statistical model 42 of FIG. 2 is performed, as represented by arrows 100. The result of this convolution also is a cumulative probability distribution 102. The horizontal axis 104 of the distribution 102 represents the actual cost of the product and the vertical axis 106 represents the cumulative probability of the product having a specific actual cost. The process 96 takes the weighted average of the actual costs and their respective cumulative probabilities, as represented by arrow 108, to establish an effective cost of a product with a specific product warranty.

Additionally, the effective cost data and the effective selling price data can be used to determine the effect that a warranty has on the profit margin of the product. The effect on the profit margin can also be expressed mathematically as a function of the effective cost data and the effective selling price data.

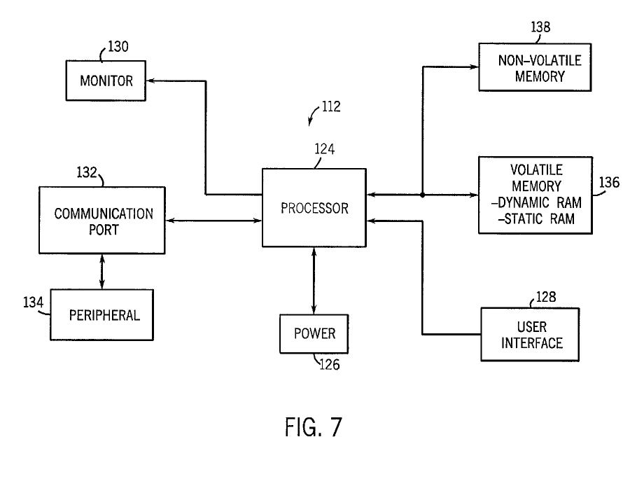

Referring generally to FIG. 7, a block diagram of an exemplary computer system that provides a user with the economic analysis tool is illustrated. The computer, generally designated by the reference numeral 112, may be any of a variety of different types, such as a server, desktop computer, notebook computer, or workstation. In the illustrated embodiment, a processor 124 controls the functions of computer 122. Computer 122 also includes a power supply 126 to supply power to various components within the computer 122. Various other devices may be coupled to processor 124, depending upon the desired functions of computer 122. In the illustrated embodiment, the computer includes a user interface 128 to enable a user to provide an input to the computer system. Examples of a user interface include a keyboard, mouse, CD-ROM, and disk drive. In this embodiment, the computer 122 is operable to produce a visual output on a monitor 130. Additionally, in this embodiment, the computer system includes a communications port 132 to enable the computer to be connected to a peripheral device 134, such as a printer.

Typically, the processor 124 utilizes computer programming to control the operation of computer 122. Memory is coupled to processor 124 to store programming and data and to facilitate execution of the programming. In the exemplary embodiment, processor 124 is coupled to a volatile memory 136 and a non-volatile memory 138. Non-volatile memory 138 also may include a high capacity memory such as a hard drive or tape drive memory. Non-volatile memory 138 may include a read only memory (ROM), such as an EPROM, to be used in conjunction with volatile memory 136. A variety of memory modules, such as DIMM”s, DRAM”s, SDRAM”s, SRAM”s, etc. also may be utilized as volatile memory 136 for a given device.

The computer is operable to provide a user with effective selling price data, effective cost data, and profit margin data for a variety of product warranty scenarios.

The statistical and economic data is supplied to the computer 122 and stored in memory. The computer programming to operate the economic analysis tool also is stored in memory. The processor performs the mathematical operations, such as the convolutions of the statistical and economic data, to produce the effective selling price, the effective cost, and the profit margin data.

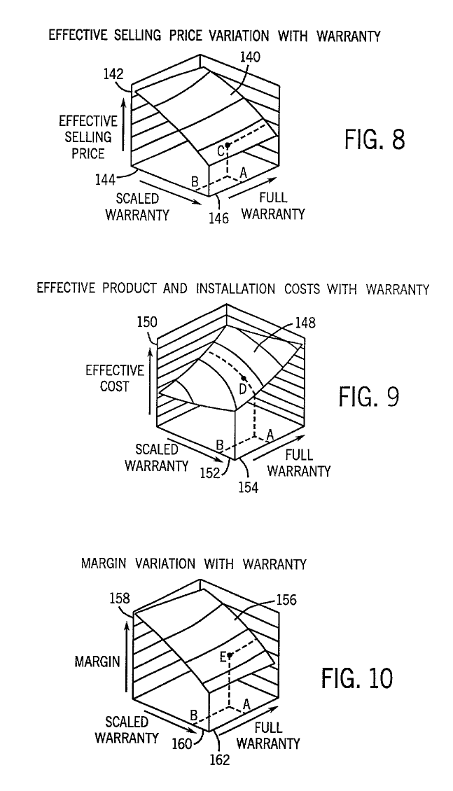

Referring generally to FIGS. 8-10, the computer system produces three-dimensional surface plots of the results of the economic analysis tool. The charts illustrated in FIGS. 3-6 illustrate a warranty having a specified full warranty period, followed by a specified scaled warranty period. However, to enable a user to perform an effective economic analysis, the economic model should reflect a range of durations for both the full warranty period and the scaled warranty period. The computer system is operable to perform the numerous mathematical operations performed in producing the effective selling price, effective cost and effective profit margin over ranges of full and scaled warranty durations. In this embodiment, the computer provides the results in the form of three-dimensional surface plots displayed on the monitor of the computer. However, this information could be printed and/or provided in a table, rather than graphically.

Referring generally to FIG. 8, a three-dimensional surface plot of the effective selling price of a replacement product, designated generally by the reference numeral 140, as a function of the duration of the full warranty and the duration of a subsequent scaled warranty is illustrated. The value of the effective selling price is represented by the vertical axis 142. The effective selling price increases vertically along the axis 142. The scaled warranty duration is represented by a second axis 144 and the full warranty duration is represented by a third axis 146. The duration of the warranties increases from left to right along the respective axes. The surface plot 140 enables a user to determine an effective selling price for a replacement product for various combinations of full and scaled warranty durations. Qualitatively, decreasing the length of the warranty periods increases the effective selling price. The illustrated plot also enables the user to identify the effective selling price for any desired full and/or scaled warranty combination. For example, for a full warranty of duration A, followed by a scaled warranty of duration B, the economic model shows an effective selling price C for a replacement product.

Referring generally to FIG. 9, a three-dimensional surface plot, designated generally by the reference numeral 148, is used to show the effective cost of a warranty as a function of the duration of the full warranty and the duration of a subsequent scaled warranty. The effective cost is represented by the vertical axis 150. The effective cost increases vertically along the axis. The scaled warranty is represented by a second axis 152 and the full warranty is represented by a third axis 154. The duration of the warranties increases generally from left to right along the respective axes. The surface plot enables a user to determine an effective cost of a warranty for various combinations of full and scaled warranty durations. Qualitatively, increasing the length of the warranty periods increases the effective cost of the warranty. The illustrated plot also enables the user to identify the effective cost of the warranty at any desired full and/or scaled warranty duration. For example, for a full warranty of duration A, followed by a scaled warranty of duration B, the economic model shows an effective cost D of providing the warranty.

Referring generally to FIG. 10, a three-dimensional surface plot of the effective profit margin resulting from a warranty, designated generally by the reference numeral 156, as a function of the duration of the full warranty and the duration of a subsequent scaled warranty is illustrated. The effective profit margin is represented by the vertical axis 158. The effective profit margin increases along the axis vertically. The scaled warranty is represented by a second axis 160 and the full warranty is represented by a third axis 162. The duration of the warranties increases generally from left to right along their respective axes. The surface plot enables a user to determine an effective profit margin for various combinations of full and scaled warranty durations. Qualitatively, increasing the length of the warranty periods decreases the effective profit margin of the warranty. The illustrated plot also enables the user to identify the effective profit margin at any desired full and/or scaled warranty duration. For example, for a full warranty of duration A, followed by a scaled warranty of duration B, the economic model shows an effective profit margin of E.

The data provided to the user by the computer enables the user to establish the duration, or other terms and conditions, of a product warranty based on quantitative economic data, rather than by simply estimating. Additionally, the system also enables a user to improve their product warranty over that of a competitor”s. For example, by using the three-dimensional surface plot of FIG. 10, a user may be able to establish a product warranty that exceeds the duration of a warranty provided by the competitor while still remaining profitable to the user to provide. Furthermore, in negotiations with a customer over the duration of a warranty, FIG. 10 can be used to quantitatively analyze the profitability of any warranty duration offered by the client.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method of quantifying the economic effect of providing a product with a product warranty, comprising the acts of:
developing a statistical model of a product”s failure rate;
developing a model of the cost over time of a product having a product warranty; and
calculating an effective cost of the product from the statistical model of a product”s failure rate and the model of the cost over time of a product having a product warranty.

2. The method as recited in claim 1, wherein calculating comprises performing a convolution of the statistical model of a product”s operating life and the model of the cost over time of a product having a product warranty.

3. The method as recited in claim 1, wherein developing a statistical model of a product”s life comprises collecting data from previous failures of the same or similar products.

4. The method as recited in claim 3, wherein developing a statistical model comprises calculating a cumulative probability of failure of the product as a function of time.

5. The method as recited in claim 1, wherein the model of the cost over time of a product includes a cost associated with a failure of a product during a warranty period.

6. The method as recited in claim 2, wherein the convolution produces a cumulative probability that the product will have an actual cost for each of a plurality of actual costs.

7. The method as recited in claim 6, wherein calculating an effective cost of a product with a product warranty comprises taking the average of the plurality of actual costs, each actual cost being weighted by its respective cumulative probability.

8. The method as recited in claim 1, wherein developing a model of the cost over time of a product having a warranty comprises developing a model of the cost over time of a product having a product warranty for each of a plurality of product warranties; and calculating comprises calculating the effective cost of a product having a product warranty for each of the plurality of product warranties.

9. The method as recited in claim 1, further comprising the act of graphically representing the effective cost of a product as a function of the product warranty.

10. The method as recited in claim 1, further comprising the act of calculating an effective selling price of a replacement product for the product having a warranty.

11. The method as recited in claim 10, further comprising the act of calculating a variation in profit of a product as a function of the product”s warranty.

12. A method of quantifying the economic effect of providing a product with a product warranty, comprising the acts of:
developing a statistical model of a product”s failure rate;
developing a model of the actual selling price of a replacement product over time; and
calculating an effective selling price for a replacement product from the statistical model of a product”s operating life and the model of the actual selling price of a replacement product over time.

13. The method as recited in claim 12, wherein calculating comprises performing a convolution of the statistical model of a product”s operating life and the model of the selling price of a replacement product overtime.

14. The method as recited in claim 13, wherein the convolution produces a cumulative probability that the replacement product will have an actual selling for each of a plurality of actual selling prices.

15. The method as recited in claim 14, wherein calculating an effective selling price of a replacement product comprises producing a weighted average of the plurality of actual selling prices and the cumulative probabilities.

16. The method as recited in claim 12, wherein developing a statistical model of a product”s life comprises collecting data from previous failures of the same or similar products.

17. The method as recited in claim 16, wherein developing a statistical model comprises calculating a cumulative probability of failure of the product as a function of time.

18. The method as recited in claim 12, wherein the model of the selling price of a replacement product over time includes discounts in the selling price of the replacement product associated with the product warranty.

19. The method as recited in claim 12, wherein developing a model of the actual selling price comprises developing a model of the actual selling prices of a replacement product for each of a plurality of product warranties and calculating comprises calculating the effective selling price of a replacement product from the convolutions for each of the plurality of product warranties.

20. The method as recited in claim 19, further comprising the act of graphically representing the effective selling price of a replacement product as a function of the product warranty.

21. The method as recited in claim 12, further comprising the act of calculating an effective cost of a product having a warranty.

22. The method as recited in claim 21, further comprising the act of calculating a variation in profit of a product as a function of the product”s warranty.

23. An analysis tool for a product having a warranty, comprising:
a computer system;
a statistical model of a product”s life stored in the computer system; and
economic data for the product stored in the computer system;
wherein the analysis tool is operable to provide a user with quantified economic information for a plurality of warranty scenarios based on the statistical model of a product”s life and the economic data for the product.

24. The analysis tool as recited in claim 23, further comprising a computer program stored in the computer system, wherein the computer program directs the computer system to produce the quantified economic information.

25. The analysis tool as recited in claim 23, wherein the quantified economic information is displayed graphically by the computer system.

26. The analysis tool as recited in claim 23, wherein the economic data comprises actual product cost for a product having a failure during a warranty period and actual product cost for a product having a failure during a non-warranty period.

27. The analysis tool as recited in claim 23, wherein the economic data comprises replacement product selling price during a warranty period and replacement product selling price during a non-warranty period.

28. The analysis tool as recited in claim 23, wherein the quantified economic information comprises effective cost data for the product over a range of warranty durations.

29. The analysis tool as recited in claim 23, wherein the quantified economic information comprises effective selling price data for a replacement product over a range of warranty durations.

30. The analysis tool as recited in claim 23, wherein the quantified economic information comprises effective profit margin data for the product over a range of warranty durations.

31. A computer program stored in a tangible medium, wherein the program enables a computer system to provide a user with quantitative economic data for a product as a function of a warranty on the product.

32. The computer program stored in a tangible medium as recited in claim 31, wherein the quantitative economic data is an effective cost of the product as a function of the warranty.

33. The computer program stored in a tangible medium as recited in 31, wherein the quantitative economic data is an effective selling price of a replacement product as a function of warranty.

34. The computer program stored in a tangible medium as recited in 31, wherein the quantitative economic data is a variation in profit margin of a product as a function of the warranty.

35. The computer program stored in a tangible medium as recited in 31, wherein the computer program directs the computer system to perform a convolution of a first model representing the cost over time of a product having a warranty and a second model representing the unreliability over time of the product.

36. The computer program stored in a tangible medium as recited in claim 35, wherein the second data set representing the unreliability over time of the product comprises a Weibull distribution.

37. The computer program stored in a tangible medium as recited in claim 35, wherein the convolution comprises a cumulative probability distribution of possible actual costs of the product.

38. The computer program stored in a tangible medium as recited in claim 37, wherein the computer program directs the computer system to perform a weighted average of the cumulative probability distribution and possible actual costs to produce an effective cost of the product.

39. The computer program stored in a tangible medium as recited in claim 38, wherein the computer program directs the computer system to produce the effective cost of the product for each of a plurality of warranty periods.

40. The computer program stored in a tangible medium as recited in claim 39, wherein the computer program directs the computer system to produce an effective selling price of a replacement product for the product.

41. The computer program stored in a tangible medium as recited in claim 40, wherein the computer program directs the computer system to produce an effective profit margin for the product from the effective cost of the product and the effective selling price of a replacement product for the product.

42. The computer program stored in a tangible medium as recited in claim 39, wherein the computer program directs the computer system to graphically display the effective cost of a product as a product of warranty.

43. The computer program stored in a tangible medium as recited in claim 40, wherein the program directs a computer system to graphically display the effective selling price of a replacement product as a function of warranty.

44. The computer program stored in a tangible medium as recited in claim 41, wherein the program directs a computer system to graphically display profit margin of a product as a function of warranty.
